(19) United States
(12) Patent Application Publication
(10) Pub. No.: US 2004/0267726 A1
(43) Pub. Date: Dec. 30, 2004

(54) Hypertext request integrity and user experience

(75) Inventors: Margaret Ann Ruth Beynon, Coventry (GB); Andrew James Flegg, Basingstoke (GB)

Correspondence Address: IBM Corporation, IP Law Department, 11400 Burnet Road, Austin, TX, 78758, US

(73) Assignee: INTERNATIONAL BUSINESS MACHINES CORPORATION, ARMONK, NY

(21) Appl. No.: 10/677,655

(22) Filed: Oct. 2, 2003

(30) Foreign Application Priority Data
Jun. 28, 2003 (GB) 0315155.2

(51) Int. Cl. G06F 7/00

(52) U.S. Cl. 707/3

(57) ABSTRACT

A method, system and computer program product for processing a URL (uniform resource location) request containing a URL for an intended URL document, comprising: retrieving fingerprint information relating to the URL request; identifying that the intended URL document is not the current document located at the URL; locating current fingerprint information which matches the retrieved fingerprint and has a corresponding URL document; and returning the corresponding URL document in answer to the request.

### FIELD OF INVENTION

This invention relates to a method, apparatus and computer program product for improving hypertext request integrity and user experience. More specifically it relates to a method, apparatus and computer program product for improving hypertext request integrity and user experience via a centralised resource.

### BACKGROUND OF THE INVENTION

One of the most prolific hypertext systems in recent years has been the World Wide Web which allows inter linked HTML (Hypertext Markup Language) documents to be transmitted between computers on the Internet using HTTP (Hypertext Transfer Protocol). Each document exists as a separate entity, which can be identified by a unique address on the network called a URL (Uniform Resource Locator). This naming scheme allows for one party to reference to another's work by including a URL which points to the referenced work such that a web site belonging to a first party links to a second party document.

A web site value is measured by the availability, accuracy, relevance and reliability of the page being linked to. When a document on the web site is removed, replaced, altered or moved such value measurements can be changed for the worse. Therefore making any change to a web site could have a detrimental effect on the value of the web site and the value of other web sites that link to it.

The problem relates to web site usability, specifically of pages which link to documents which subsequently move, change, disappear or get replaced. These interconnecting links form the backbone of the World Wide Web and are often a valuable business tool in forming alliances and cross-promotion.

This is also a more general problem affecting any application which uses links or pointers set up between items of information, for example, entries in a relational database.

The problem of broken links is so severe that Google™ (Google is a trademark of Google Technology Inc.) has taken to caching whole documents that people can view if the located URL results is a broken link. Another solution from Google is to find similar documents for documents located in a search. Although this is not specifically limited to broken links it can be useful when a document is not available due to a broken link. ‘Similar documents’ in a Google search means other documents in the same category as the located document and Google specifically excludes very close matches to the located document. It is possible to use Google's ‘cached pages’ feature to try and find a cached document of a broken link but one needs to goto a Google site and enter the URL itself. Identifying the URL is not always intuitive to the typical user and the result of the search would also not reliably identify an appropriate replacement page.

Although the above are directed to completely broken links, the problem is related to a returned URL document content that is not originally intended when the link was originally created.

Methods exist which automatically forward a URL request to a new page. In the particular case of HTTP, if a web site owner is aware that a document that was linked-to has moved, and they know where it has moved to, they can set up their site so that when the resource is accessed a ‘302 Moved’ response is sent. However, the onus is on the web site owner to find the new location of the page and to manually set up the redirection facility. Also the web site administrator must allow this facility to be set up. A problem for a web site administrator is that the content of the site is owned by someone other than the web site administrator but that complaints about broken links are more likely to come to the web site administrator especially on an intranet. A typical corporate site has over 100 different content owners, and so the web site administrator cannot track the individual status of over 6000 documents. Content owners can redirect visitors to a document's new location using a variety of manual techniques, however can only do this if the web site owner facilitates it and decides to do so. There is no automatic process for doing this.

An object of at least one of the embodiments is to locate the information and URL document that the content owner originally intended to link to and return this URL document in response to a URL request.

Another object of at least one of the embodiments is to update stored information as frequently as it is configured to do so and to provide information on demand.

### DISCLOSURE OF THE INVENTION

According to a first aspect of the present invention there is provided a method of processing a URL (uniform resource location) request containing a URL for an intended URL document, comprising: retrieving fingerprint information relating to the URL request; identifying that the intended URL document is not the current document located at the URL; locating current fingerprint information which matches the retrieved fingerprint and has a corresponding URL document; and returning the corresponding URL document in answer to the request.

The above steps are controlled by a request forwarder component. The retrieved fingerprint information may be archive fingerprint information controlled by a resource location broker (RLB) or intended fingerprint information controlled by a link controller. Current fingerprint information is searched using the RLB component. All URL requests to a web server of the present embodiment are received by a request forwarder.

When there is no URL document at the URL location, the URL request is automatically forwarded to a new URL using fingerprint information retrieved from an archive fingerprint database based on the URL. In this way the requester does not see an error message when the original URL location is empty. Instead of archive fingerprint information a cache copy of the URL document can be used to generate a fingerprint.

Alternatively, the retrieved fingerprint information is retrieved from an intended fingerprint database based on the link containing the URL, this allows a comparison between the intended fingerprint information and the fingerprint information of the current URL document. The comparison of the fingerprint information identifies whether the intended URL document is materially different from the current URL document located at the URL.

The step of locating current fingerprint information preferably comprises: finding, on the current fingerprint database, a current fingerprint that corresponds with the URL of the request.

The step of locating current fingerprint information preferably comprises: receiving from a server, fingerprint information corresponding to the URL request. The server is one or the following: the originator of the URL request; a first web server maintaining the link selected by the originator of the URL; a second web server being the target of the URL; a remote broker server. The server comprises an intended fingerprint database with corresponding links, the step of locating the intended fingerprint comprises: locating link information in the URL request; locating the intended fingerprint in the intended fingerprint database using the link information; returning the located intended fingerprint.

A URL (uniform resource location) defines the location in the Internet of a document, such a document is referred to as a URL document. A link is a URL reference, it is physical code or mark-up language in a document (called a link document henceforth) that includes a URL, refers to a URL document, and may refer to a position within the URL document. Although a link document can be a URL document and vice versa the two documents are normally distinct in this specification and it is not envisaged that they would refer to the same document in the same context in this specification. A link reference is physical code or mark-up language (in a data structure distinct from a link document and a URL document) that includes the link, refers to the link document and may refer to the position of the link in the link document.

Generating a fingerprint of a document comprises calculating a potentially unique numerical value in multidimensional content space for that document which is distinct from categorising the document in a defined index structure. A material difference in simplest terms is a percentage change in the content of the document and depends on the embodiment. A difference of more than 5% of the content of a document can be taken as more than a material difference in the document whereas a difference of 50% can be consider a completed changed document and essentially a broken link.

Fingerprint information is a fingerprint or in some embodiments be a complete URL document from which a fingerprint can be created.

In a first embodiment a web server comprises: a plurality of URL documents, a request forwarder; a current fingerprint database of the fingerprints of the plurality of URL documents; and an archive fingerprint database of the fingerprints of previous URL documents store on the web server. A browser downloads a link document and selects a link to URL document on the web server. A URL request is sent from the browser to the web server and received by the request forwarder. For the case when there is no URL document is at the URL the request forwarder performs the method of the first aspect of the invention and returns the a URL document according to that method. For the case when there is URL document at the URL with chandged content the first embodiment simply returns this. The current fingerprint database and the archive fingerprint database may be the same database. It is advantageous to keep the old fingerprints in the same database as this saves having to move them to another database or delete them. In this embodiment the retrieved fingerprint will be found amongst the URL documents which are no longer at their URLS.

A problem exists with the first embodiment in that there is no detection of changed content of documents since there is no faeture that can tell the request forwarder what the intended document is. The second and perferred embodiment addresses this problem.

The second and preferred embodiment comprises: a plurality of URL documents, a request forwarder; a current fingerprint database of the fingerprints of the plurality of URL documents; an intended fingerprint database of the fingerprints of URL documents with respect to the links that point to them. A browser downloads a link document and selects a link to URL document on the web server. A URL request is sent from the browser to the web server and received by the request forwarder. For the case when there is URL document at the URL with changed content the second embodiment acquires the intended fingerprint associated with the originating link and compares this with the fingerprint of the existing document in the method of the invention. For the case when there is no URL document is at the URL the request forwarder locates a URL and current fingerprint which match the intended fingerprint and returns the located URL and corresponding document according to that method.

According to a second aspect of the present invention there is provided a system as described in claim 10.

According to a third aspect of the present invention there is provided a computer program product as described in claim 19.

Although the preferred embodiment is described in terms of Internet technology the invention is also suited for application in other forms of document and requests for documents. For instance, the invention could be implemented for database records having pointers in links embedded in a link document.

The method preferably further comprising: spidering from a seed URL; creating current fingerprints from the seed URL document and descendent URL documents; and storing the current fingerprints and associated URLs. Such spidering of URL documents is needed to populate the current fingerprint database.

The matched current URL document may correspond to a copy of the original URL document, a previous or future version of the originally requested document, or another URL document closely related to the original URL document by virtue of its content. If the original URL document has been changed significantly then another URL document may match the intended fingerprint better.

In the preferred embodiment the current fingerprint database and the archive fingerprint database are controlled and accessed by a resource location broker (RLB).

The aspect of separating the RLB, link controller and the request forwarder allows for flexibility of the solution to several configurations of web server and third party broker.

### BRIEF DESCRIPTION OF THE DRAWINGS

In order to promote a fuller understanding of this and other aspects of the present invention, embodiments of the invention will now be described, by means of example only, with reference to the accompanying drawings in which:

FIG. 1 shows a schematic system overview of a preferred embodiment of the invention including a link controller; a resource location broker; and request forwarder in a system of two web servers; and a browser;

FIG. 2 shows a more detailed schematic of the link controller;

FIG. 3 shows a more detailed schematic diagram of the resource location broker;

FIG. 4 shows a more detailed schematic diagram of the request forwarder;

FIG. 5 shows a web document that is the target of the preferred embodiment;

FIG. 6 shows a more detailed schematic of the method of the link controller;

FIG. 7 shows a more detailed schematic of the method of the RLB; and

FIG. 8 shows a more detailed schematic of the method of the request forwarder.

### DESCRIPTION OF THE PREFERRED EMBODIMENTS

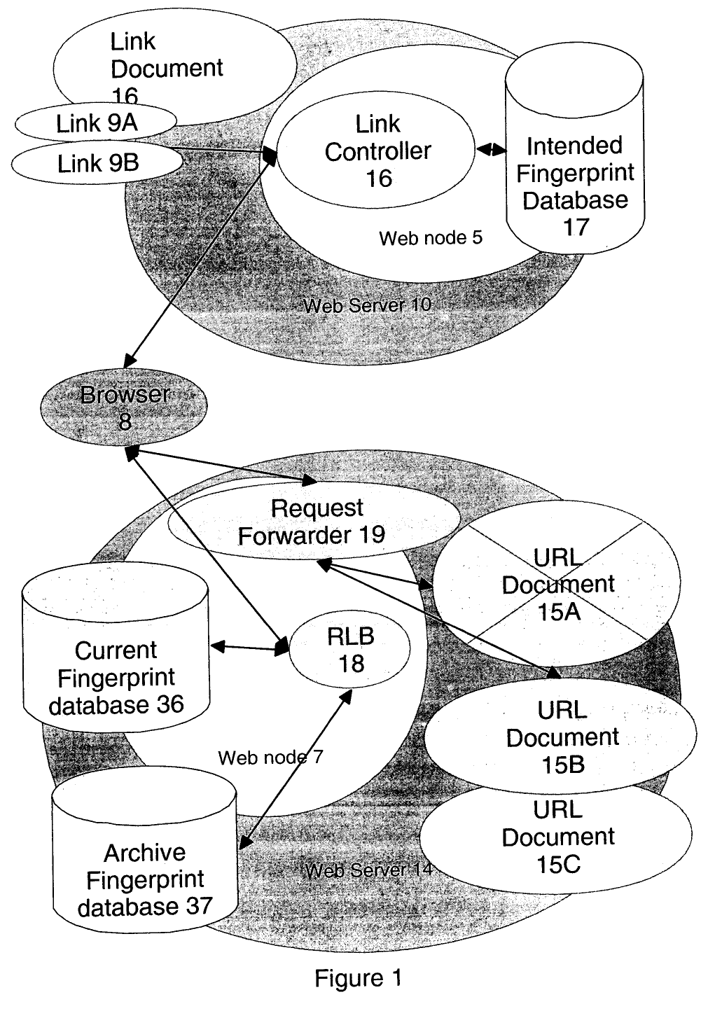

Referring to FIG. 1 there is shown a schematic system overview of the preferred embodiment. The preferred embodiment is implemented for a system comprising a browser 8; a first web server 10; and a second web server 14. Web server 10 comprises: web node component 5; link document 14 having a links 9A and 9B. Web node 5 comprises: a link controller 16 and intended fingerprint database 17; all residing within the web server 10. Web server 14 comprises web node 7; URL document 15A; URL document 15B and URL document 15C. Web node 7 comprises: resource location broker (RLB) 18; request forwarder 19; current fingerprint database 36; and archive fingerprint 37; all residing within web server 14. In the preferred embodiment the web node component 5 also comprises all the components of web node component 7 and vice versa so that both web node components can perform the functions of the request forwarder; RLB; or link controller. It is envisaged that many web node components could exist and communicate on a network together as link controllers and/or request forwarders. However, in this description the two functions are described and shown separately with respect to the two web node components 5 and 7.

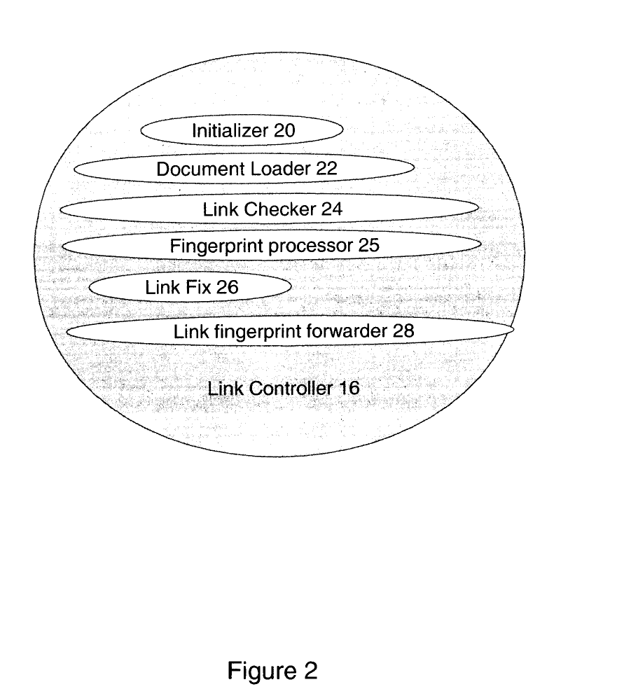

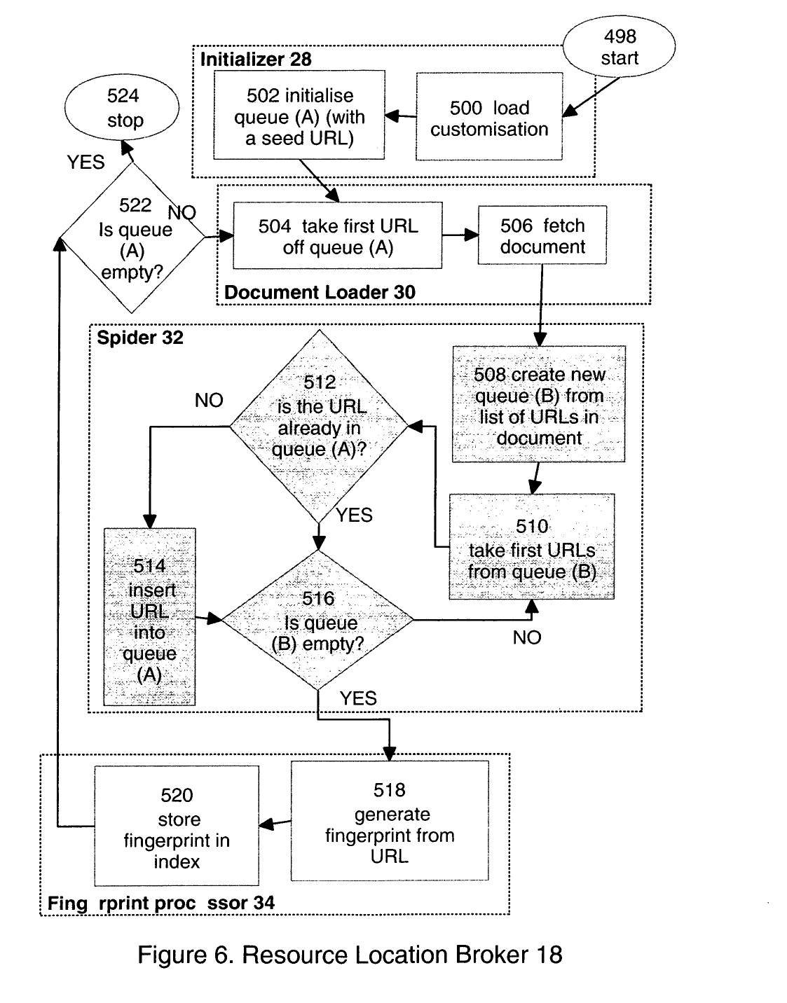

With respect to FIG. 2, the link controller 16 comprises: an initialiser 20; a document loader 22; a link checker 24; a fingerprint processor 25; link fix component 26; and link fingerprint forwarder 28. The methods of the link fixer 16 are described below with respect to FIG. 6.

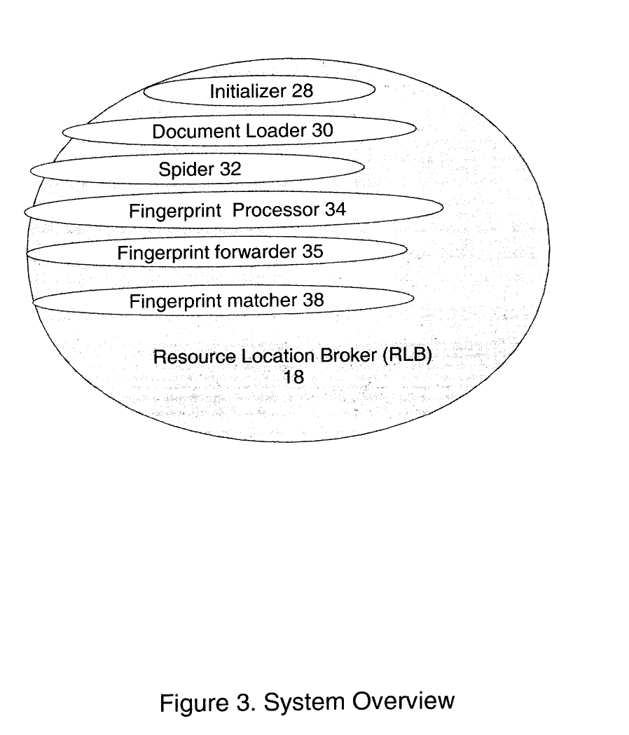

With respect to FIG. 3, RLB 18 comprises: an initialiser 28; a document loader 30; a spider 32; a fingerprint processor 34; a fingerprint forwarder 35 and fingerprint matcher 38.

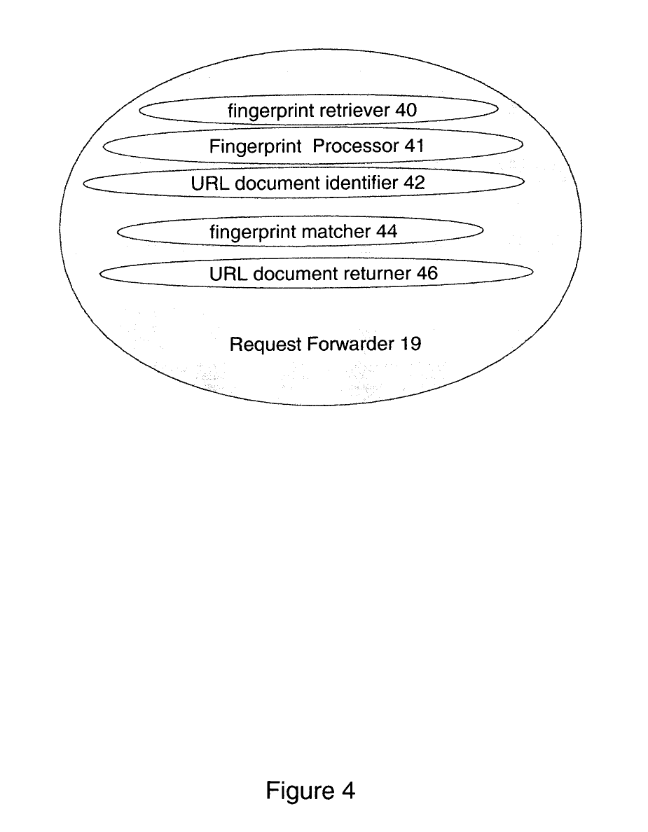

With respect to FIG. 4, request forwarder 19 comprises: fingerprint retriever 40; fingerprint processor 41; URL document identifier 42; fingerprint matcher 44; and URL document returner 46.

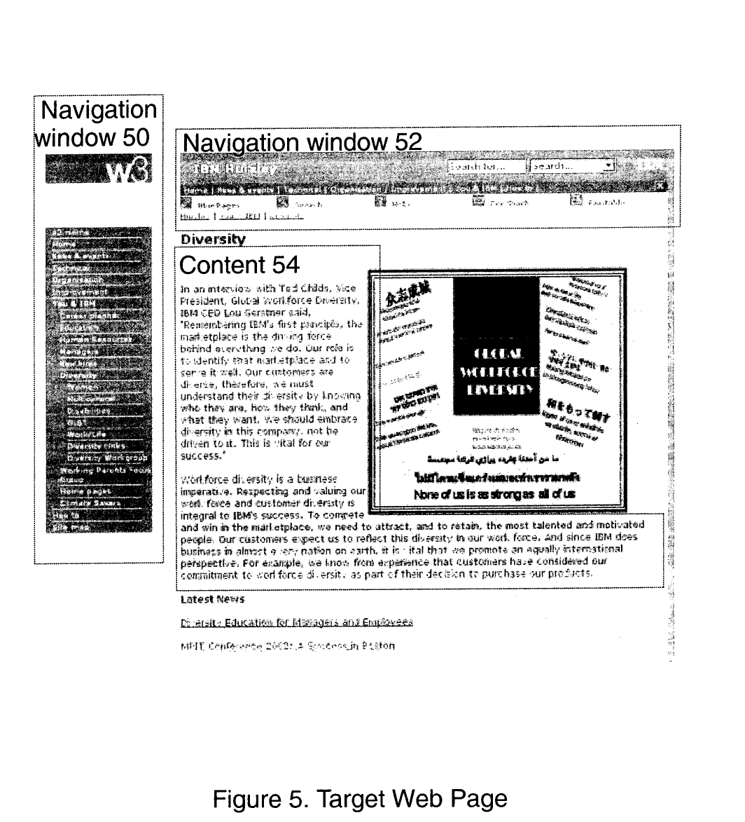

Referring to FIGS. 1, 2, 3 and 4 in the preferred embodiment, the fingerprint processor 25 in the link controller 16, fingerprint processor 34 in the RLB 18 and fingerprint processor 41 in the request forwarder 19 are able to parse a URL document completely to locate the contents and then generate a unique identification for the document from the contents. The fingerprint processors scan a document, for example as is shown in FIG. 5, and ignore parts of the document which are not content. In an HTML document the fingerprint processors can ignore table cells which are solely used for navigation within a site, and pass the remainder as content to the fingerprint generator stage. FIG. 5 shows a fairly common layout of navigation down the left hand side (navigation window 50), a standard header (navigation window 52) and a large content area 54 indicated by the dotted lines. The parser isolates the content area 54 to the exclusion of the navigation areas in the preferred embodiment and provides such content area for fingerprint generating. Meta data from the document is included in fingerprint generation because it can help to source and locate different versions of the same document when it is difficult to tell from small changes in the content.

In another embodiment of the invention, the navigation area is used in the creation of the fingerprint as it can help set the position of the document within the web site.

The fingerprint is a numerical representation of the content of the document and may be considered a multidimensional vector in content space. It is stored in a matrix format using normal array structures. Note, however, that checksum algorithms such as MD5 would not be appropriate as the result of an MD5 sum on a document varies wildly with small changes.

The fingerprint is defined by certain properties: Property 1—unique identifier for content rather than URL; Property 2—guaranteed same identifier generated for same content; Property 3—comparable with another identifier to find degree of difference; Property 4—small change in content results in small change in identifier; Property 5—large change in content results in small change in identifier; Property 6—degree of difference between identifiers represents degree of difference in content; Property 7—content cannot be derived from the identifier; Property 8—generated from main content and not static headers and footers; and Property 9—storage requirements less than average content. For the system to correctly identify moved content, it needs to store a unique identifier which can be used to locate the same content at a different URL or the closest approximation to it.

In the preferred embodiment and referring to FIG. 1, link controller 16 sits in the web server 10 and provides the functionality for retrieving intended fingerprints from database 17. It also spiders through all the links and creates an intended fingerprint for each one in the database 17. An optional feature of the link controller is to physically change link 9 when it no longer points to a URL that reflects the intended link, this optional feature in this patent specification is the subject of a separate patent specification. The actual changing of the link is performed by a link fix 26. This link fixing aspect of the link controller 16 is executed whenever the web server 10 wants to fix links in link containing documents on the client or on a server that it has publish access to.

Web server 14 contains documents (15A, 15B And 15C). Document 15A has a URL contained in link 9A of document 14 on web server 10 and Document 15B has a URL contained in link 9B of document 14 on web server 10. With the intention of increasing clarity, documents on web server 14 are referred to as URL documents and the document on web server 10 containing a link that is referenced in the description is called a link document. However, essentially both types are documents and both types may contain links.

The intended fingerprint database 17 can store a fingerprint for each occurrence of a link in the link document 14. For the same URL there may be several links and therefore several fingerprint entries in intended fingerprint database 17. Such fingerprints are referred to as intended fingerprints because the fingerprint represents the content of the referenced document at the time of or soon after the creation of the link.

Referring to FIG. 2, Initialiser 20 generates a starting link list by scanning all HTML documents on the web server 10 for links. Typically this will include all the documents on the client's database.

Document loader 22 is an optional component for the link fixing aspect but not the request forwarding aspect. When enabled it loads a link document into working memory.

Link checker 24 is an optional component for the link fixing aspect but not the request forwarding aspect. When enabled it tests the intended fingerprint with a newly generated fingerprint for the URL of the link and determines if the URL document is non-existent. If there is no intended fingerprint then link checker 24 will forward the link on to the fingerprint processor 25 so that a new fingerprint can be generated and stored for future use. A newly generated fingerprint can be referred to as a current fingerprint but once it is stored with respect to a particular link it becomes an intended fingerprint.

Link fix 26 is an optional component for the link fixing aspect but not the request forwarding aspect. When enabled it has two inputs for a first condition when a link URL returns a URL document and a second condition when a link URL does not return a URL document. In the first case, if the URL document is considered the same as intended by the link, nothing is done and the component passes control. However, in the first case, if the URL document considered different enough to that intended, a new URL is located that matches better the original intention of the link. The intention is assumed to be as indicated by the intended fingerprint. A query containing the intended fingerprint is passed to the RLB and a new URL is returned. If the new URL returns a URL document that is considered similar enough then the link in the link document is edited to that returned URL, if not then the link is marked as broken. In the second case, a query containing the intended fingerprint is passed straight to the RLB and a new URL is returned. Again, if the new URL returns a URL document that is considered similar enough then the link is edited to such a URL, if not then the link is marked as broken.

Link fingerprint forwarder 28 receives requests for link fingerprints pertaining to a particular link, it acquires them from the intended fingerprint database and forwards them to the requester. Such requests come from request forwarders, e.g. request forwarder 19.

Other functionality such as controlling the components when spidering in relation to a list of links is performed by the Link controller 16.

Referring to FIG. 3, the resource location broker (RLB) 18 is a centralised resource which has three main functions. Firstly to spider a defined set of hypertext URL documents and store current fingerprints for all the content found. Secondly to accept queries to retrieve a current fingerprint for a given URL. Thirdly to find a matching current fingerprint for a given fingerprint.

The first function is performed by the initialiser 28; document loader 30; spider 32; and fingerprint processor 34 and described with respect to the components of the RLB 18 in FIG. 3. A description of the method steps are described later with respect to FIG. 6. The initialiser 28 supplies a first URL to start the spidering, such a URL is a search engine index root for maximum coverage so that queue A starts with a seed URL and traverses each link for subsequent links until there are no more links. The document loader 30 loads a URL document at the first link URL in the queue. The spider 32 proceeds to create a new list, queue B, of all the URLs in the downloaded document and to add them to queue A if they are not already there. Fingerprint processor 34 creates and stores a fingerprint for the document. The RLB 18 manages the next URL in queue A and passes it, step 504, on to the document loader or exits if there is no more URLs.

The second function is performed by fingerprint forwarder 35. Fingerprint forwarder 35 accepts requests to locate a fingerprint from fingerprint databases using a URL as the index. Once located the fingerprint is sent back to the requester.

The third function is performed by the fingerprint matcher 38. Fingerprint matcher 38 accepts queries in the form of a first fingerprint and searches the current fingerprint database 36 for matching fingerprints and corresponding fingerprints and URLs. The nearest matching fingerprint and URL is sent back to the requester. In a variation of this several matching fingerprints with corresponding URLs are returned so that the requester can choose between them.

Referring to FIG. 4, fingerprint retriever 40 is for retrieving fingerprint information relating to a Url request. Fingerprint processor 41 is used in some embodiments to generate a fingerprint from a URL document. Alternatively the fingerprint is simply retrieved from a fingerprint database. The URL document identifier 42 compares fingerprints and decides whether there is a material difference. Fingerprint matcher 44 searches in the current fingerpint database 36 for URL with matching fingerprints. URL document returner 46 returns the matched document to the browser.

The RLB spider process will now be described in relation to FIG. 6. Steps 500 to 502 are performed by the link fixer initialiser 20. Step 500, load settings such as the seed link; links to include/exclude from spidering, for example: limiting spidering to within company and blocking inappropriate content. Step 502, start of the spidering process. A queue of links (A) is initialised with a seed link.

Steps 504 to 506 are performed by the RLB document load 22. Step 504, a URL document pointed to by the top link in the queue A is fetched, (referred to as the document in progress) and the top link is removed from queue A, step 506.

Steps 508 to 516 are performed by the RLB spider 32. Step 508, start of the sub process for inserting all links in the URL document into queue A. A new queue (B) is created from all the links in the URL document. For example, by parsing the HTML and extracting all the ‘href’ attributes from ‘a’ tags. Step 510, the next link in the queue (B) is taken from it. Step 512, if the link is not already present in queue (A), it is inserted step 514. Step 516, are there more links in queue (B)? If so, go back to step 510. Otherwise, end of the sub process for inserting all links in the URL document into queue (A) and move onto step 518.

Steps 518 and 520 are performed by the Fingerprint processor 34. Step 518, the fingerprint (a current fingerprint) for the URL document in progress is calculated. Step 520, the current fingerprint is stored in a current fingerprint database using an index against the URL of the link which allows rapid searching by querying for fingerprints within a specified difference.

Step 522 queries whether there are more links in queue (A). If so, skip to 504. Otherwise, end of the spidering process step 524.

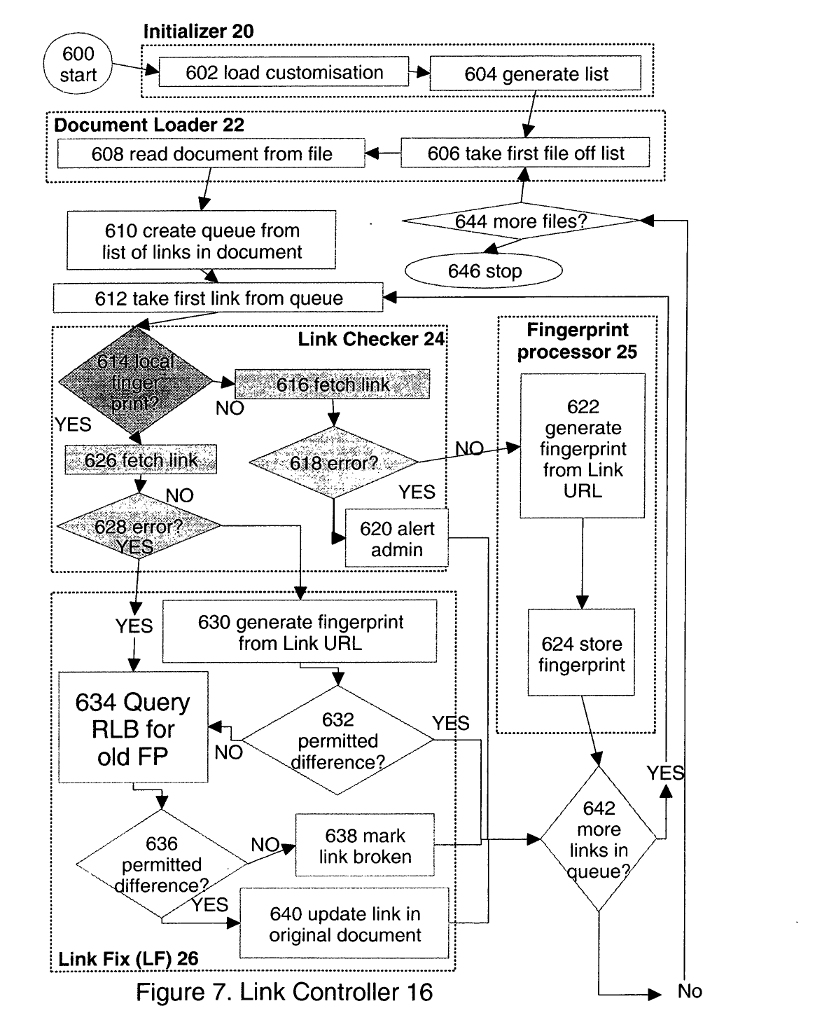

The optional link controller fixing process will now be described with respect to FIG. 7. Step 600 is the start of the process in the link fixer 16.

Steps 602-604 performed in initialiser 20. Step 602, user settings are loaded which, for example, will define: the threshold for automatic changing of links; and the administrator email address. Step 604, a list of all hypertext files under the document root is created.

Steps 606-608 are performed by the document loader 22. Step 606, the next file in the list is taken from the head of the list and loaded, step 608, into memory.

Step 610, start of checking individual links. A list of links within the client document is retrieved or created. For example, by parsing the client's HTML link documents and extracting all the ‘href’ attributes from ‘a’ tags.

Step 612, the first link in the list is taken from the link list and placed in working memory.

Steps 614, 616, 618, 620, 626 and 628 are performed by the Link Checker 24.

Step 614, the link is checked to see if a intended fingerprint is associated with it, such a intended fingerprint may have been created at installation or from an earlier run of the software. The intended fingerprint is loaded into a working memory.

Step 616, start of sub process where a intended fingerprint is not available. The linked URL document is fetched into a working memory.

618 If an error code is returned, than administration is alerted, step 620, to the fact that the link is broken. This is the limit of current broken link checking software. The next step is step 642.

Steps 622-624 are performed by fingerprint processor 25.

If, step 618, an error code is not returned, the current fingerprint of the fetched URL document in the working memory is calculated, step 622, and stored, step 624, in working memory. Skip to 642.

Step 626 in the link checker 24 is the start of sub process where the intended fingerprint is available. Step 626, the linked URL document is fetched.

Step 628, checks to see if an error code is returned to signify that there is no URL document at this URL. If no URL document at the URL then skip to step 634 in link fix 26. If there is a URL document then go to step 630 in the link fix 26.

Steps 630-640 are performed by the link fix 26. Step 630, start of sub process where error code is not returned. The current fingerprint of the URL document in working memory is calculated and placed into working memory, step 630, and compared, step 632, with the intended fingerprint. If the difference is above a set threshold, then skip to step 634; otherwise if the difference is below the set threshold then skip to 642. End of sub process where error code is not returned.

Step 634 finds identical current fingerprints for the intended fingerprint by making a request to the RLB 18. The RLB 18 performs a search (see FIG. 6C) for current fingerprints which are within a specified difference and returns the set of URL links, associated current fingerprints, and associated differences. In an adapted embodiment two fingerprints are sent to the RLB in a current fingerprint lookup, the intended fingerprint and also the fingerprint of the link document so that the RLB search can take account of the types of documents linking to the linked document when determining the best match.

In step 636, the results are checked at the client and a URL is chosen from the results. Some results will not be acceptable to the client for various reasons and the client can choose which URL to link to. It may be that none of the results are suitable and the difference between the fingerprints is above a second threshold which in this embodiment is the same as or similar to the first threshold. In this case step 638 is next otherwise step 640.

In step 638, if the difference between the closest result and the intended fingerprint is above the second threshold then the link is marked as broken. A routine for notifying the web master of the broken link is called, typically writing the list of broken links and closest URLs returned by the RLB 18 to a system file. This is the end of sub process where intended fingerprint is available and the process moves to step 642.

Step 640, the difference between the current fingerprint and the intended fingerprint is below the set threshold. The URL of the link in the link document is substituted for the URL of the chosen current fingerprint. The process moves to step 642.

Step 642, are there more links to check in this link document? If so the process goes back to step 612. Otherwise, this is the end of on link document and the process moves to step 644.

Step 644, are there more link documents in the list? If so, go to step 606, if not this is the end of the process.

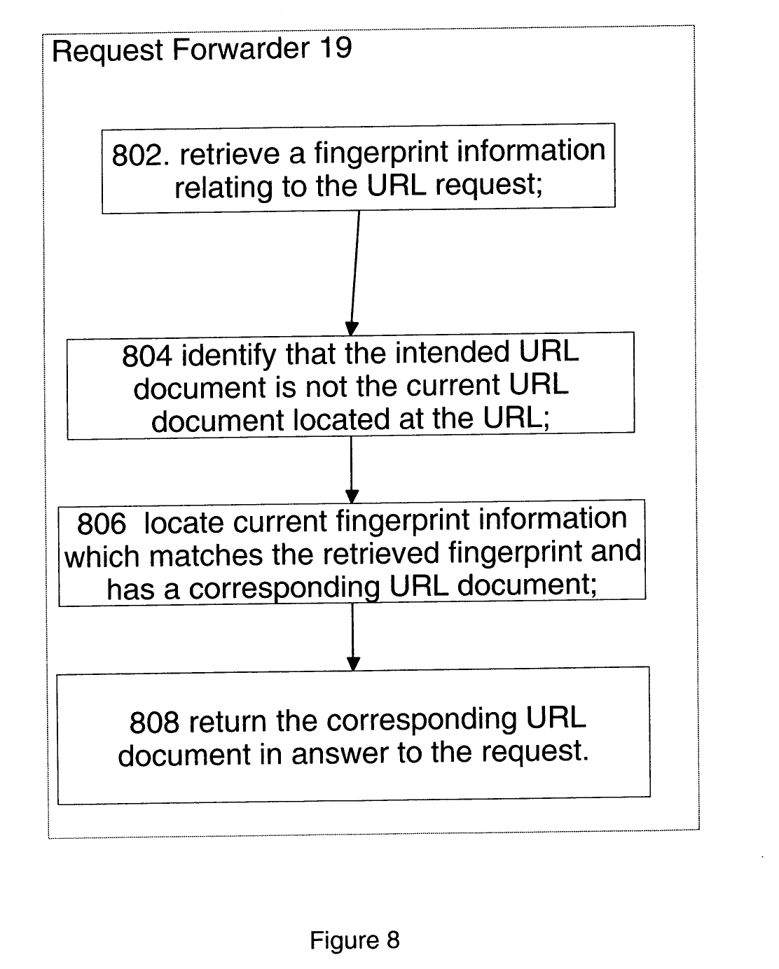

The request forwarder process is described with request to FIG. 8.

Step 802. A URL request from browser 8 is incident on the request forwarder 19. If the URL address does not have the URL document then the URL itself can be used to retrieve fingerprint information from an archive fingerprint database but if there is no archive information then the request forwarder can look to the intended fingerprint database nevertheless. Information from the URL request regarding the origin of the request is included in the request and contains the link reference of the URL request. A query for the intended fingerprint database is sent to the web server from where the link resides. Such a request is received by the link controller 16 and a look up made on the intended fingerprint database 17. The result is returned to the request forwarder 19. The advantage of using a fingerprint from an archive fingerprint database is that it is quicker to retrieve.

Step 803 the fingerprint processor calculates the fingerprint of the URL document at the URL location

Step 804 the intended fingerprint retrieved from link controller 16 and the calculated fingerprint from step 803 are compared, if the intended fingerprint is materially different to the calculated fingerprint of the document then the content has changed and the remaining steps of the process are performed. If the two fingerprints are similar then the content has not changed, the document is returned to the browser and the process ends.

Step 806, using the intended fingerprint, the RLB is requested to provide a matching fingerprint and corresponding URL. Current fingerprint information is located which matches the retrieved intended fingerprint and a corresponding URL document returned.

Step 808 the corresponding URL document is returned in answer to the original request.

An example of the operation of the preferred embodiment is described. The general solution presented here provides an application which can be installed on a web server to auto-forward URL requests. Although the solution below uses terms appropriate to web site maintenance, the same concepts can be directly applied to the more general case of any system containing linked information.

RLB 18 is a central resource which is aware of all URL documents which may be linked to, not just those on web server 14 but URL documents on any number of web servers. For each document RLB 18 stores the document URL and a current fingerprint which uniquely identifies the content presented in the document.

The mapping of URLs to fingerprints in a current fingerprint table is similar to table 1 below:

| URL | Fingerprint |
|---|---|
| www.abc.com/manual.HTML | AAA AAA AAA AAG |
| www2.abc.com/manual.HTML | AAA AAA AAA AAG |
| www.xyz.com/product/zz9plA.HTML | GCA TCG ATA DOG |
| www.xyz.com/product/cat.HTML | GCA TCG ATA CAT |
| www.xyz.com/index.HTML | TAC GAT GTA CGT |
| www.xyz.com/index.HTML#part1 | AAG AGA GTT ACC |
| www.xyz.com/index.HTML#part2 | GCC ATT TGA CTA |

Table 1 Example Portion of a Current Fingerprint Database

| URL | Fingerprint |
|---|---|
| www.xyz.com/product/cat.HTML | GCA TCG ATA CAT |

Table 2 Example Portion of Archived Fingerprint Database

Link controller 16, maintains a intended fingerprint table similar to the table 3 below:

| Link | Fingerprint |
|---|---|
| www.abc.com/home/web/htdocs/ | AAA AAA AAA |
| example.HTML:: | |
| www.abc.com/manual.HTML | AAG |
| www.abc.com/home/web/htdocs/ | AAA AAA AAA |
| example.HTML:: | |
| www2.abc.com/manual.HTML | AAG |
| www.abc.com/home/web/htdocs/ | GCA TCG ATA CAT |
| example.HTML:: | |
| www.xyz.com/product/zz9plA.HTML | |
| www.abc.com/home/web/htdocs/ | TAC GAT GTA CGT |
| example.HTML:: | |
| www.xyz.com/index.HTML | |
| www.abc.com/home/web/htdocs/ | AAG AGA GTT ACC |
| example.HTML:: | |
| www.xyz.com/index.HTML#part1 | |
| www.abc.com/home/web/htdocs/ | GCC ATT TGA CTA |
| example.HTML:: | |
| www.xyz.com/index.HTML#part2 | |
| www.abc.com/home/web/htdocs/ | AAA AAA AAA |
| example2.HTML:: | |
| www.abc.com/manual.HTML | AAG |
| www.abc.com/home/web/htdocs/ | AAA AAA AAA |
| example2.HTML:: | |
| www2.abc.com/manual.HTML | AAG |
| www.abc.com/home/web/htdocs/ | GCA TCG ATA CAT |
| example2.HTML:: | |
| www.xyz.com/product/zz9plA.HTML | |
| www.abc.com/home/web/htdocs/ | TAC GAT GTA CGT |
| example2.HTML:: | |
| www.xyz.com/index.HTML | |
| www.abc.com/home/web/htdocs/ | AAG AGA GTT ACC |
| example2.HTML:: | |
| www.xyz.com/index.HTML#part1 | |
| www.abc.com/home/web/htdocs/ | GCC ATT TGA CTA |
| example2.HTML:: | |
| www.xyz.com/index.HTML#part2 | |

Table 2 Example Portion of a Intended Fingerprint Table.

Link 9A contains a URL for URL Document 15A and is intended to point to content regarding cats (www.xyz.com/product/cat.HTML). Unfortunately Document 15A is an example of a non-existent document on the web server 14 since it has been deleted although its fingerprint is stored in the archive fingerprint database.

In the prior art, requests to web server 14 for document 15A would return an error code (such as ‘404 not found’ with a protocol such as HTTP) for the URL being queried. In the prior art, requests to web server 14 for URL document 15B would return a document but one that was not intended. However, in the present invention, the request forwarder would intercept the request and the following steps would result.

Since there is no document for link 9A fingerprint information must be retrieved. First step is the archive database and by chance the URL has been stored with a corresponding fingerprint “www.xyz.com/product/cat.HTML”=“GCA TCG ATA CAT”. In this case step 803 is not performed and step 804 is fulfilled as there is no URL document at that location. In step 806 RLB is requested to find a current fingerprint and URL that matches “GCA TCG ATA CAT”. A search of the current fingerprint database reveals that “www.xyz.com/product/cat.HTML”=“GCA TCG ATA CAT”. At step 808 the document at www.xyz.com/product/cat.HTML is returned instead of a page not found error. Alternatively to searching the archive fingerprint database, a request to the link controller for an intended fingerprint for the link 9A may be requested. This is similar to the next example except step 804 is fulfilled again since there is no current URL document.

Link 9B contains a URL for URL document 15B and is intended to point to content regarding cats (www.xyz.com/product/zz9plA.HTML). Unfortunately the content of document 15B has been changed to discuss dogs (see item 3 “www.xyz.com/product/zz9plA.HTML”=“GCA TCG ATA DOG” in the current fingerprint table).

A browser selects link 9B in document and a URL request is received by request forwarder 19. Step 802, the URL of the request is received, the URL document is downloaded and the fingerprint calculated: “GCA TCG ATA DOG”. If the current fingerprint database is kept up-to-date then the fingerprint maybe retrieved from this database by lookup.

As part of the URL request, link information is provided: “abc.com/home/web/htdocs/example2.HTML: www.xyz.com/product/zz9plA.HTML”. This link information is used to query the link controller for a fingerprint. The link controller uses the link information to look up a fingerprint and returns “GCA TCG ATA CAT” (see table 3). Needless to say the intended fingerprint “GCA TCG ATA CAT” does not match current fingerprint “GCA TCG ATA DOG”.

So step 806, the intended fingerprint “GCA TCG ATA CAT” is used to search the current fingerprint database and returns URL document 15C www.xyz.com/product/cat.HTML. URL document 15C discusses cats (www.xyz.com/product/cat.HTML—see item 4 in the current fingerprint table). The URL document from this location is returned in response to the original browser request.

Although the preferred embodiment is described in terms of its main components it is assumed that these component boundaries need not be limited to the methods described since the invention maybe implemented in many ways including object oriented program techniques, procedural techniques and a mixture of both.

Although the embodiments are described in terms of a client which fixes links on local documents on the client or intranet, the documents can be anywhere on a network where the client has publisher access. In a further embodiment the client is a web service and charges its user for fixing links.

What is claimed is:

1. method of processing a URL (uniform resource location) request containing a URL for an intended URL document, comprising: retrieving fingerprint information relating to the URL request; identifying that the intended URL document is not the current document located at the URL; locating current fingerprint information which matches the retrieved fingerprint and has a corresponding URL document; and returning the corresponding URL document in answer to the request.

2. A method as in claim 1 wherein the above steps are controlled by a request forwarder component.

3. A method as in claim 1 wherein the retrieved fingerprint information is archive fingerprint information controlled by a resource location broker (RLB) or intended fingerprint information controlled by a link controller.

4. A method as in claim 1 wherein current fingerprint information is searched using the RLB component.

5. A method as in claim 1 wherein all URL requests to a web server of the present embodiment are received by a request forwarder.

6. A method as in claim 1 wherein where there is no URL document at the URL location, the URL request is automatically forwarded to a new URL using fingerprint information retrieved from an archive fingerprint database based on the URL.

7. A method as in claim 6 wherein instead of archive fingerprint information a cache copy of the URL document can be used to generate a fingerprint.

8. A method as in claim 1 wherein the retrieved fingerprint information is retrieved from an intended fingerprint database based on the link containing the URL.

9. A method as in claim 1 wherein the step of locating current fingerprint information preferably comprises:
finding, on the current fingerprint database, a current fingerprint that corresponds with the URL of the request.

10. A system of processing a URL (uniform resource location) request containing a URL for an intended URL document, comprising:
means for retrieving fingerprint information relating to the URL request;
means for identifying that the intended URL document is not the current document located at the URL;
means for locating current fingerprint information which matches the retrieved fingerprint and has a corresponding URL document; and returning the corresponding URL document in answer to the request.

11. A system as in claim 10 wherein the above means are controlled by a request forwarder component.

12. A system as in claim 10 wherein the retrieved fingerprint information is archive fingerprint information controlled by a resource location broker (RLB) or intended fingerprint information controlled by a link controller.

13. A system as in claim 10 wherein current fingerprint information is searched using the RLB component.

14. A system as in claim 10 wherein all URL requests to a web server of the present embodiment are received by a request forwarder.

15. A system as in claim 10 wherein where there is no URL document at the URL location, means automatically forwards the URL request to a new URL using fingerprint information retrieved from an archive fingerprint database based on the URL.

16. A system as in claim 15 wherein instead of archive fingerprint information a cache copy of the URL document can be used to generate a fingerprint.

17. A system as in claim 10 wherein the retrieved fingerprint information is retrieved from an intended fingerprint database based on the link containing the URL.

18. A system as in claim 10 wherein the means for locating current fingerprint information preferably comprises: means for finding, on the current fingerprint database, a current fingerprint that corresponds with the URL of the request.

19. A computer program product for processing one or more sets of data processing tasks relating to a url request containing a URL for an intended URL document, said computer program product comprising computer program instructions stored on a computer-readable storage medium, for, when loaded into a computer and executed, causing a computer to carry out the steps of: retrieving fingerprint information relating to the URL request; identifying that the intended URL document is not the current document located at the URL; locating current fingerprint information which matches the retrieved fingerprint and has a corresponding URL document; and returning the corresponding URL document in answer to the request.
